(19) United States
(12) Patent Application Publication
(10) Pub. No.: US 2009/0228840 A1
(43) Pub. Date: Sep. 10, 2009

(54) SYSTEMS AND METHODS FOR IMPROVING WEB BROWSING EFFICIENCY

(76) Inventor: Jason Edward Stach, Avondale Estates, GA (US)

Correspondence Address: Jason Edward Stach, 428 Wilfawn Way, Avondale Estates, GA, 30002, US

(21) Appl. No.: 12/044,941

(22) Filed: Mar. 8, 2008

(51) Int. Cl. G06F 3/048

(52) U.S. Cl. 715/854

(57) ABSTRACT

A method for more efficiently browsing the Internet is provided, comprising receiving a button or link through the Internet, wherein the button or link has been designated to be a super button or link, and entering a predefined input sequence to directly access the super button or link. A system for more efficiently browsing the Internet is also provided, comprising a software module configured to receive a button or link on an Internet web page, wherein the button or link has been designated to be a super button or link. The software is also configured to recognize the super button or link as being a super button or link, and permits a user to directly access the super button or link upon entering a predefined input sequence. A method for more efficiently browsing the Internet is provided, comprising designating a button or link on an Internet page to be a super button or link, and providing the super button or link to a user running software capable of recognizing the super button or link and permitting the user to directly access the super button or link upon the user's entry of a predefined input sequence.

### TECHNICAL FIELD

This invention relates generally to more efficient Internet browsing, and more specifically to methods and systems for providing at least one super button or link selectable by a predefined input sequence.

### BACKGROUND

Over the past decade, the Internet has become an increasingly popular communication tool. Through the Internet, a user can perform a multitude of tasks, including everything from reading current news articles to shopping to viewing family photos. As the popularity of the Internet has increased, tools for navigating the Internet have also evolved. Internet content providers, meaning those companies and individuals that create or distribute content on the Internet, often spend significant time and resources developing or acquiring their content so that it is user-friendly and can be quickly and easily navigated. Likewise, individuals and companies have spent significant resources devising better browsing mechanisms to assist a user in navigating Internet content. Despite all of this development, there continues to be room for improvement in assisting users in navigating the Internet.

For example, users often perform searches for information. The results are often contained on multiple web pages. According to the prior art, to navigate to the next page of the search results, the user must find a button or link, usually labeled “Next” or the like, use an input device to move a cursor to the button or link, and then select the button or link. It is desirable to be able to select this button or link without having to complete all of the above actions. A system or method of achieving the same result (i.e., navigating to the next page) with fewer steps is highly desirable, particularly given the repeated and common nature of the task. Such a system or method would result in great overall time savings and improved usability for web content.

### SUMMARY

In one embodiment consistent with one aspect of the present invention, a method for more efficiently browsing the Internet is provided, comprising receiving a button or link through the Internet, wherein the button or link has been designated to be a super button or link, and entering a predefined input sequence to directly access the super button or link.

In another embodiment consistent with one aspect of the present invention, a system for more efficiently browsing the Internet is provided, comprising a software module configured to receive a button or link on an Internet web page, wherein the button or link has been designated to be a super button or link. The software is also configured to recognize the super button or link as being a super button or link, and permits a user to directly access the super button or link upon entering a predefined input sequence.

In yet another embodiment consistent with one aspect of the present invention, a method for more efficiently browsing the Internet is provided, comprising designating a button or link on an Internet page to be a super button or link, and providing the super button or link to a user running software capable of recognizing the super button or link and permitting the user to directly access the super button or link upon the user's entry of a predefined input sequence.

The foregoing background and summary are not intended to be comprehensive, but instead serve to help artisans of ordinary skill understand the following implementations consistent with the invention set forth in the appended claims. In addition, the foregoing background and summary are not intended to provide any independent limitations on the claimed invention.

### DETAILED DESCRIPTION

The following description discusses implementations that are consistent with the principles of the claimed invention. This description is not intended to be limiting, and it does not represent all implementations consistent with principles of the claimed invention. Instead, these are merely some examples of systems and methods consistent with those principles.

As embodied herein, a user interface provides the user with an improved browsing experience by reducing the number of actions required to select common buttons or links on the Internet. In an exemplary embodiment, an Internet content provider provides Internet content containing a button or link that has been identified by that provider as a super button or link. This super button or link may, for example, be the “next” button on a webpage. However, the Internet content provider can choose any button or link to be a super button or link. A user's computer is configured to recognize buttons or links that have been designated as super buttons or links. For example, the user's Internet browser may interpret and recognize buttons or links that have been designated as super buttons or links. Instead of having to find, navigate to, and select the super button or link, the user is able to access it by using a predefined input mechanism. This input mechanism can be any keystroke, mouse click, voice command, mouse gesture (e.g., pressing a left mouse button while moving the mouse to the right), or any other command or combination of command that can be performed by the user.

The super button or link differs from current systems in that the Internet content provider identifies it as a super button or link, and the user's computer recognizes it as a super button or link. In current systems, for example, web browsers recognize buttons and links, but do not differentiate one button or link from another in the sense that none of the buttons or links has a higher priority or status than the others. Thus, if a web page has five buttons or links, they are treated in the same manner, and the user may select them by placing the cursor over them and utilizing the appropriate input mechanism, such as clicking the left mouse button.

In contrast, one embodiment consistent with the present invention would designate one of those five buttons or links as a super button or link. Without having to place the cursor on the link or button, the user can simply use a predefined input sequence to effectively click on the super button or link, without the need to scroll through the document, locate the super button or link, place the cursor on it, and click or activate it. The other buttons or links remain accessible in the traditional manner, but the super button is treated differently and is directly accessible via the specially defined input sequence.

The super button or link also differs from the “Next Page” button found in many Internet browsers. That button in the Microsoft Internet Explorer and Mozilla Firefox browsers is typically represented by an arrow pointing to the right of the user's screen. It is only accessible if a user has navigated to a web page, and then has clicked the “Back” button in the browser to step backwards in the web history to a page previously visited. At that point, the “Next Page” button becomes active (it is typically “grayed out” until it becomes active at this point, allowing users to select it). Selecting it will take the user forward in the browsing history to a page that had been previously visited.

This differs from embodiments consistent with the present invention utilizing a super button or link. For example, in the conventional system, the user must have already visited the page that is accessible via the “Next Page” button. In systems and methods consistent with the present invention, a user need not have already visited a web page for the super button or link to take the user to, say, the next page of search results, or the next image in an online photo gallery. Indeed, the traditional “Next Page” button in the web browser does not even need to be accessible (i.e., it may be “grayed out”) for the super button or link to work and perform its function. In short, the “Next Page” button is a tool for walking through a history of pages already browsed, not a tool for moving to, say, the next page of search results even if those results had never been visited before.

Let's now turn to an example of one embodiment consistent with the present invention. Take, for example, a retail shopping site on the Internet. Users often send search criteria related to what they seek, and the shopping site will provide a list of search results. For concise visual presentation, to improve download times, to reduce bandwidth usage, and/or for other reasons, the list of search results is often divided into multiple web pages. The first web page may contain, for example, the first ten search results. To access the next ten, the user has at least two options. The first is to follow the traditional system of locating the appropriate button or link (usually designated something like “next” or “more results”), navigating the cursor to that button or link, and then selecting it. This traditional method is still available for users. However, in a system or method consistent with the present invention, the user has a second, more efficient option.

In the second approach, the Internet content provider has already identified the appropriate button or link (e.g., the “next” or “more results” button or link) as being a super button or link on the web page. To access the next set of search results, the user then simply submits a predefined input sequence on one or more interface devices. For example, the user could click a dedicated button on a mouse, press a key or combination of keys on a keyboard, use a mouse gesture, state an appropriate voice command, or use any other predefined input sequence. Upon submitting the predefined input sequence, the super button or link will be activated, taking the user to the next page of search results. There is no need for the user to locate or navigate to any particular button or link on the web page, nor is it necessary to select any particular button or link. Indeed, the super buttons links need not even be visible on the user's screen for the user to be able to access them through an embodiment consistent with the present invention.

In certain embodiments, the Internet content provider designates the super button or link, such as by using a special HyperText Markup Language (“HTML”) tag. However, embodiments consistent with the present invention need not utilize HTML tags, but could instead use any suitable mechanism for designating a super button or link as being distinct from other buttons or links on the web page.

In certain embodiments, the Internet content provider may specify multiple super buttons or links. The user would be able to access the super buttons or links in a manner similar to the embodiments discussed above containing only a single super button or link, but the user may utilize different predefined input sequences for each. For example, an Internet content provider could designate one super button or link as the “next” or “more results” button or link. The user could access that super button or link by pressing, for example, a special input button on a mouse. The Internet content provider could designate a second super button or link as the “help” button or link. The user could access this second super button or link by using a different input sequence from the first, such as by pressing a certain key on the keyboard.

Using this approach, it is entirely possible that the industry may settle on a single standard for web pages, where “next” or “more results” buttons are defined and accessed by users in a common manner, and “help” or other types of buttons or links are also commonly defined and accessed. Just as uniformity aids users in quickly grasping local applications, such as the common menu structure found Microsoft Office products, the same uniformity can aid users in efficiently browsing web pages.

Once the Internet content provider has defined one or more super buttons or links, the user's computer must recognize which buttons or links are super buttons or links. This can be accomplished through software on the user's computer, and will typically reside in the user's web browser either natively or through one or more plug-ins. In one embodiment, when a web page is downloaded and rendered, the web browser will recognize which buttons or links have been designated as super buttons or links. The browser is configured to associate those super buttons or links with one or more predefined input sequences of the user, such as the pressing of a particular button on a keyboard or mouse. When the user provides the appropriate input sequence, the browser may select the appropriate super button or link, taking the user to the appropriate web page. In the example of the search results discussed above, the next set of search results may be displayed.

While the super button or link may be accessible to the user as a normal link on a web page, thus allowing the user to access it in the traditional locate-navigate-select method, a super button or link could instead be hidden in the web page, such that it is not accessible by the traditional method. Rather, the user would need to provide the proper input sequence to access the super button or link. This may be desirable for purposes of saving space on a web page for other things, such as photographs or other graphics.

When it comes to the user's input sequence, any input type or mechanism will suffice as long as it has been predefined as any entry mechanism for super buttons or links. For example, computer mice have evolved over the years to contain additional buttons and scroll wheels. These buttons are at times assigned web browsing functions, such as scrolling through a web page or moving forward or backward in the browsing history. In one embodiment, it is envisioned that an additional button may be added to a mouse, and that button may be designated the preferred input mechanism for selecting a super button or link. In other embodiments, other existing mouse buttons could be defined to select a super button or link, such as pressing down on a scroll wheel to click it.

Ultimately, users have a large amount of flexibility in defining which button or buttons, voice commands, mouse gestures, keystrokes, or other input sequences will be used to access the super buttons or links on a web page. Software on the user's computer, preferably in the user's web browser or contained in one or more plug-ins for the browser, will allow the user to customize the particular input sequence or sequences the user desires for directly accessing super buttons or links. Thus, different input sequences may be used by different users to access the same super buttons or links, allowing the users to select the mechanisms that are most logical or comfortable for them.

Now let's assume that an Internet content provider has not identified a super button or link. In one embodiment consistent with the present invention, software on the user's computer (preferably a web browser or one or more plug-ins for a web browser) uses an algorithm for identifying which buttons or links on a web page should be treated as super buttons or links. For example, one may browse to a shopping website, conduct a search, and receive multiple pages of results. The shopping site has not identified any of the buttons or links as being super buttons or links. Nonetheless, the browser may use various criteria to analyze the web page and determine which buttons or links should be considered super buttons or links. In this example, the browser may look for keywords in the buttons or links, such as the words “next” or “more results.” It may then independently define those buttons or links as super buttons or links, thus providing the user with the benefit of more efficient browsing even in the absence of the Internet content provider's prior identification of them as being super buttons or links. Various algorithms for identifying super buttons or links will be apparent to those skilled in the art, but a few non-exhaustive examples include the use of keywords to identify the functions of certain buttons or links, as well as the placement of the buttons or links on the page (as “next” or “more results” buttons or links are often in the lower-right corner of a web page). Those skilled in the art will understand that additional suitable algorithms may be used without departing from the scope of the present invention.

In yet another embodiment where the Internet content provider has not identified a super button or link, rather than have a web browser guess at which buttons or links should be treated as super buttons or links through the use of algorithms, the web browser may draw upon a locally or remotely stored list of super buttons or links for commonly-accessed web sites. For example, a user could navigate to a commonly-used web site, such as Amazon.com, and conduct a search yielding multiple pages of results. In the background, and preferably seamlessly from the user's perspective, the user's web browser or a plug-in for that browser would examine a stored list of super buttons or links, seeking information related to Amazon.com. If Amazon.com was found in the list, it would then pull from that list which buttons or links should be treated as super buttons or links. It would then treat those buttons or links as super buttons or links, just as if the Internet content provider had identified them as such in the first place. Once again, the user gets the benefit of more efficient web browsing even in the absence of the Internet content provider's identification of super buttons or links.

In certain embodiments, the local or remote lists of super buttons or links can be updated by users. For example, if a particular web site is not in the database, the user could manually identify the super buttons or links on a web page, and then add them to the database. The next time the user browses to that same site, it will now be in the database and the user's software will treat the appropriate buttons or links as super buttons or links. Thus, the manual identification of super buttons or links will likely only need to be accomplished once for each web page.

In one embodiment, software on a user's computer will first try to detect whether the Internet content provider has identified super buttons or links. If not, it will then examine a stored table or list of super buttons or links for certain web sites. If the particular site or web page is not in the table or list, software on the user's computer or remotely hosted will use an algorithm to try to ascertain which buttons or links should be treated as super buttons or links. If that succeeds, the user is given the option of adding the identified super buttons or links to its local or remote database of super buttons or links. If the algorithm does not find any super buttons or links, the user is notified and given the option to define one himself.

The methods disclosed herein are not limited in their order. For example, if an Internet content provider has designated a super button or link, software on the user's computer may recognize the designation and understand it as such upon downloading it. Alternatively, software on the user's computer may delay detecting the super button or link until the user initiates the predefined input sequence. Thus, in one embodiment, the user may download the Internet content, but his system will not attempt to recognize any super button or link designations until the user has, for example, pressed the predefined input sequence. At that time, software on the user's computer, such as a web browser or plug-in, will verify that a super button or link has been designated and will select that super button or link if it exists. If none exists, it may try to detect super buttons or links through the use of algorithms, or it may try to locate super buttons or links by utilizing a locally or remotely stored table of super buttons or links.

The systems and methods disclosed herein may be implemented using any suitable hardware and/or software. It is not intended to be limited to any particular computing environment. It could, for example, work well under Microsoft Windows 95/98/Me/2000/XP/Vista, various versions of Mac OS, various versions of Linux, and virtually any other operating system that supports web browsing. It can be implemented through any software on a person's computer or Internet-capable device, including Microsoft Internet Explorer, Apple Safari, Mozilla Firefox, Opera, or any other web browser or non-browser application. The disclosed systems and methods may also be used on any type of Internet-enabled hardware, including without limitation PCs, Macs, laptops, mobile phones (e.g., iPhones, Blackberries, etc.), and MP3 players (e.g., iPod Touches). Those skilled in the art will appreciate that other user modifications can be made to the disclosed systems and methods without departing from the scope of the present invention.

As used herein, the terms “button or link” and “buttons or links” should be broadly construed to mean any portion of a web page that can be selected by a user. The word “predefined” encompasses those items predefined by anyone, including items predefined by the Internet content provider, predefined by the user, or predefined by the user's software or the companies or people that wrote the user's software. The term “input sequence” refers to any press of a mouse button, any mouse gesture, any voice command, any keystroke, and/or any other input mechanism without limitation. The term “input sequence” refers to both singular events, such as a single mouse click or keystroke, or a combination of events, such as clicking multiple mouse buttons or entering multiple keystrokes either simultaneously or in succession. As used herein in the context of accessing buttons or links, the terms “directly access” and “directly accessing” refer to selecting or accessing a button or link without the need to locate and navigate to it. The term “upon” refers to the time either at or anytime after the specified event. The terms “software” or “software on the user's computer” refer not only to software residing locally on the user's local drives or in local RAM, but also remotely hosted software that does not permanently reside on the user's local computing hardware. Also, while “next” and “more results” buttons or links were used in the examples in this disclosure, super buttons or links may comprise any button or link on a web page, regardless of name or type.

Those skilled in the art will appreciate that all or part of the disclosed systems and methods may be stored on or read from computer-readable media, such as secondary storage devices (e.g., hard disks, floppy disks, and CD-ROMs); carrier waves received from the Internet; or other forms of computer-readable memory (e.g., read-only memory (ROM) or random-access memory (RAM)).

The foregoing description of possible implementations consistent with the present invention does not represent a comprehensive list of all such implementations or all variations of the implementations described. The description of only some implementations should not be construed as an intention to exclude other implementations. Artisans will understand how to implement the invention in the appended claims in many other ways, using equivalents and alternatives that do not depart from the scope of the following claims. Moreover, unless indicated to the contrary in the preceding description, none of the components described in the implementations is essential to the invention.

I claim:

1. A method for more efficiently browsing the Internet comprising:
receiving a button or link through the Internet, wherein the button or link has been designated to be a super button or link; and
entering a predefined input sequence to directly access the super button or link.

2. The method of claim 1 wherein the predefined input sequence comprises clicking a predefined button on a computer mouse.

3. The method of claim 1 wherein the predefined input sequence is capable of being customized by the user.

4. The method of claim 1 wherein more than one button or link has been designated to be a super button or link.

5. The method of claim 4 wherein each super button or link has a separate predefined input sequence associated with it.

6. The method of claim 1 wherein the super button or link is hidden from the user.

7. The method of claim 1 wherein the super button or link is designated as such by an appropriate HTML tag.

8. A system for more efficiently browsing the Internet comprising:
a software module configured to receive a button or link on an Internet web page, wherein the button or link has been designated to be a super button or link, the software also being configured to recognize the super button or link as being a super button or link, and permitting a user to directly access the super button or link upon entering a predefined input sequence.

9. The system of claim 8 wherein the predefined input sequence comprises clicking a predefined button on a computer mouse.

10. The system of claim 8 wherein the predefined input sequence is capable of being customized by the user.

11. The system of claim 8 wherein more than one button or link has been designated to be a super button or link.

12. The system of claim 11 wherein each super button or link has a separate predefined input sequence associated with it.

13. The system of claim 8 wherein the super button or link is hidden from the user.

14. The system of claim 8 wherein the super button or link is designated as such by an appropriate HTML tag.

15. A method for more efficiently browsing the Internet comprising:
designating a button or link on an Internet page to be a super button or link; and
providing the super button or link to a user running software capable of recognizing the super button or link and permitting the user to directly access the super button or link upon the user's entry of a predefined input sequence.

16. The method of claim 15 wherein the predefined input sequence comprises clicking a predefined button on a computer mouse.

17. The method of claim 15 wherein the predefined input sequence is capable of being customized by the user.

18. The method of claim 15 wherein more than one button or link has been designated to be a super button or link.

19. The method of claim 18 wherein each super button or link has a separate predefined input sequence associated with it.

20. The method of claim 15 wherein the super button or link is designated as such by an appropriate HTML tag.
